(19) United States
(12) Patent Application Publication
(10) Pub. No.: US 2018/0177568 A1
(43) Pub. Date: Jun. 28, 2018

(54) ENDODONTIC INSTRUMENT FOR DRILLING ROOT CANALS

(71) Applicant: FKG DENTAIRE S.A., La Chaux-de-Fonds (CH)

(72) Inventors: Olivier BREGUET, Le Locle (CH); Jean-Claude ROUILLER, La Chaux-de-Fonds (CH)

(73) Assignee: FKG DENTAIRE S.A., La Chaux-de-Fonds (CH)

(21) Appl. No.: 15/324,491

(22) PCT Filed: Jul. 6, 2015
(86) PCT No.: PCT/CH2015/000098

§ 371 Date: Jan. 6, 2017

(30) Foreign Application Priority Data
Jul. 7, 2014 (CH) 1020/14

(51) Int. Cl. A61C 5/42; A61C 3/03; A61C 1/00

(52) U.S. Cl. CPC A61C 5/42; A61C 3/03; C22F 1/006; A61C 2201/007; A61C 1/0069

(57) ABSTRACT

An endodontic instrument (10) for preparing a tooth of a patient, in particular an instrument for cleaning the root canal that follows the natural geometry of the canal. The instrument (10) comprises a rigid tip (11) arranged to be mounted on a rotating support (102) of an apparatus (103), known as a contra-angle, and a working sector (12). The working sector (12) comprises a free end section (13) which is arranged to engage in the root canal (101). The working sector (12) is composed of a first essentially straight active segment (14) disposed in the extension of the rigid tip (11), and at least one second active segment (15) comprising the free end section (13). In the static state, the second active segment (15) is substantially straight and, in the dynamic state, the second active segment (15) has a curved shape.

This application is a National Stage completion of PCT/CH2015/000098 filed July 6, 2015, which claims priority from Swiss patent application serial no. 1020/14 filed Jul. 7, 2014.

### TECHNICAL FIELD

This invention relates to an endodontic instrument for preparing a tooth of a patient, in particular an instrument for cleaning the root canal that follows the natural geometry of said canal, said instrument being made of shape memory material and having a first static state and a second dynamic state, said first static state corresponding to an essentially straight geometry for facilitating the partial introduction of the instrument into said root canal and said second dynamic state corresponding to a structured geometry and a supple and flexible hold, said endodontic instrument being driven in rotation in order to clean the inner wall of said root canal by following its natural geometry, and having a rigid tip arranged for being mounted on a rotating support, and a working sector arranged for being engaged in said root canal.

The cleaning and shaping of the root canals of a tooth for the purpose of receiving filling materials is typically carried out by means of drilling instruments having an active or so-called working portion, the purpose of which is to form, trim, and clean the inside walls of the root canal in order to prepare it for receiving the treatment materials and then a filling material, in order to exclude any oxygen that could enable bacteria to develop in the tooth and particularly in the vicinity of the root.

This type of instrument for drilling root canals typically comprises an active portion or so-called cutting section having a conical envelope and one or more cutting edges wound helically along said active portion. These instruments tend to “shave” the walls of the canal, in other words to cut into the dentin without really taking the natural shape of the canal into account by following the path thereof. However, recent studies indicate that cutting into the dentin is not recommended because the tooth is weakened as a consequence of this procedure. The most skilled endodontists try to adhere to these guidelines and endeavor to find rotary instruments that are designed to allow them to follow the root canal and thoroughly clean its walls regardless of the overall profile and morphology of said canal, considering that it varies from one individual to another. On the one hand, it is known that the root canal profiles vary greatly among patients, and that these canals frequently have an irregular oval cross section along their length and that they can have one or more narrowings and curved sectors.

Indeed, nearly all current endodontic instruments for drilling a root canal are in principle straight, even though some have a certain flexibility that enables them to adapt to some extent to the longitudinal profile of the root canal. However, such flexibility cannot guarantee effective cleaning of the entire wall when the latter has variations in curvature and cross section. Furthermore, the envelope for the space brushed by a standard instrument driven in rotation about its longitudinal axis is nearly cylindrical or conical due to the axially symmetric geometry of this instrument such that the walls of a root canal with an oval cross section cannot be brushed by a single instrument, but require a series of instruments, the sections of which are scalable. The practitioner is, therefore, compelled to change instruments during a procedure, starting with small and then progressively larger diameters, which is not only tedious but also does not guarantee that the walls are cleaned effectively without damaging the dentin.

Because they do not correspond to the root canal morphology, on the one hand, and because they comprise several cutting edges, on the other hand, that shave and mill the dentin of the walls of the canal rather than simply following its profile for cleaning the surface thereof, nearly all root canal drilling instruments currently available on the market do not fulfill the requirements of numerous practitioners. Furthermore, the relative rigidity of these instruments only makes it possible to mill cylindrical or conical orifices each time, and not even the translational movement along the rotational axis of the instrument, parallel thereto, makes it possible to clean all of the surfaces of the walls if the latter are oval with irregular areas and have narrowings along their lengths.

Hence there is a need for novel instruments that satisfy the requirements of practitioners, namely, instruments of sufficient suppleness for following the profile of the canal, for contacting all of the rough and uneven areas of the walls of the canal, and for brushing them to remove the inner biofilm without cutting into the dentin.

International Patent Application WO 20121079183 A1 describes an endodontic instrument that has a straight retracted form when it is in the so-called martensitic phase in the resting position or static state, and a structured form when it is in the austenitic phase in the working position or dynamic state, the transition from the so-called martensitic phase into the austenitic phase being brought about by a temperature change. In the dynamic state, the instrument has a twisted, spiral shape with several twists along its length, these twists capable of slowing and braking the rotation of the instrument, which is subjected to significant mechanical stresses.

U.S. Pat. No. 5,836,764 describes an endodontic instrument comprising a pre-curved end region that is intended to facilitate the insertion of the instrument into a curved root canal. However, it does not solve the problem of introducing the tip of the instrument into canals of complex shapes and it cannot in any case adapt to such shapes by changing its shape during use, as is the case with instruments made of a shape-changing material.

### Disclosure of the invention

This invention has as an object for the creation of an instrument that fulfills all of the requirements expressed by practitioners with regard to preparation of root canals. To this end, this instrument effectively satisfies the constraints imposed in preparing such a canal by following its profile precisely, by cleaning the walls thereof without cutting into, by milling, the dentin in which it is positioned, in other words, by scraping the walls thereof in order to detach the soft matter constituting the biofilm but without cutting into the harder bony matter known as dentin. The instrument, according to the invention, is arranged to carry out these operations effectively regardless of the morphology of the canal, in particular, if the canal is either entirely or partially oval in cross section, whether or not it has narrowings along its length, whether it is essentially straight or curved with angular variations along its length, and whether its walls are smooth or have rough areas.

This object is achieved by the endodontic instrument according to the invention as defined at the outset and, in the dynamic state of the instrument, said working sector is composed of a first, essentially straight active segment and of at least a second active segment disposed in the extension of said first active sector, said at least one second active segment having a free end tip with a curved shape between the point of connection to said first active segment and said free end tip, said second, curved active segment having a sagitta (d), the length of which is between the largest half cross section (a) of said root canal and the smallest half cross section (b) of said root canal.

Different embodiments are envisioned. Said free end tip can have a structured geometric shape.

Said end tip can have a beveled shape. Said bevel advantageously has an angle of between 30° and 60° and preferably at least approximately equal to 45°.

Said free end tip can comprise a dovetailed tip. Said dovetail preferably has an opening angle in the range of between 60° and 30° and preferably in the vicinity of 45°.

Said free end tip can comprise a flared tip. Said free end tip advantageously has a flare defined by a curvature radius (R1).

Said free end tip advantageously has a widening defined by an angle that is essentially between 120° and 150°,

According to another embodiment, it [the instrument] is made of a shape memory metal alloy in which the transition from the martensitic phase to the austenitic phase occurs naturally when the body temperature is between 32° C. and 37° C.

According to a variant, it [the instrument] is made of a shape memory metal alloy in which the transition from the martensitic phase to the austenitic phase is brought about by a temperature increase induced by injecting a hot liquid or by applying vibrations induced by ultrasound.

It [the instrument] can be advantageously made of a metal alloy having super elastic properties acquired as a result of a heat treatment.

### BRIEF DESCRIPTION OF THE FIGURES

This invention and its advantages will be more clearly understood by reading the detailed description of preferred embodiments of the instrument and by referring to the appended drawings, which are provided as examples and are not limiting, wherein:

FIG. 1 illustrates the instrument according to the invention, shown in a static state and engaged in the root canal of a tooth to be treated,

FIG. 2 illustrates the instrument according to the invention, shown in a dynamic state and engaged in the root canal of a tooth to be treated,

FIGS. 2A and 2B are cross sectional views of the tooth of the patient along a plane A-A and along a plane B-B parallel to the plane A-A, respectively, and disposed at different levels,

FIG. 3 is a view, similar to that of FIG. 2, showing the instrument according to the invention in the dynamic state engaged in the inside of the root canal during a second treatment phase,

FIG. 4 is a view, similar to that of FIG. 3, showing the instrument according to the invention in the dynamic state engaged in the inside of the root canal during a third treatment phase,

FIGS. 5 and 6 illustrate a first embodiment of the instrument according to the invention in its static state and in its dynamic state, respectively,

FIG. 7 illustrates a second embodiment of the instrument according to the invention in its dynamic state,

FIG. 7A is a detailed view of the end of the instrument of FIG. 7,

FIG. 8 illustrates a third embodiment of the instrument according to the invention in its dynamic state,

FIG. 8A is a detailed view of the end of the instrument of FIG. 8,

FIG. 9 illustrates a second embodiment of the instrument according to the invention in its dynamic state, and

FIG. 9A is a detailed view of the end of the instrument of FIG. 9.

### BETTER WAYS OF EMBODYING THE INVENTION

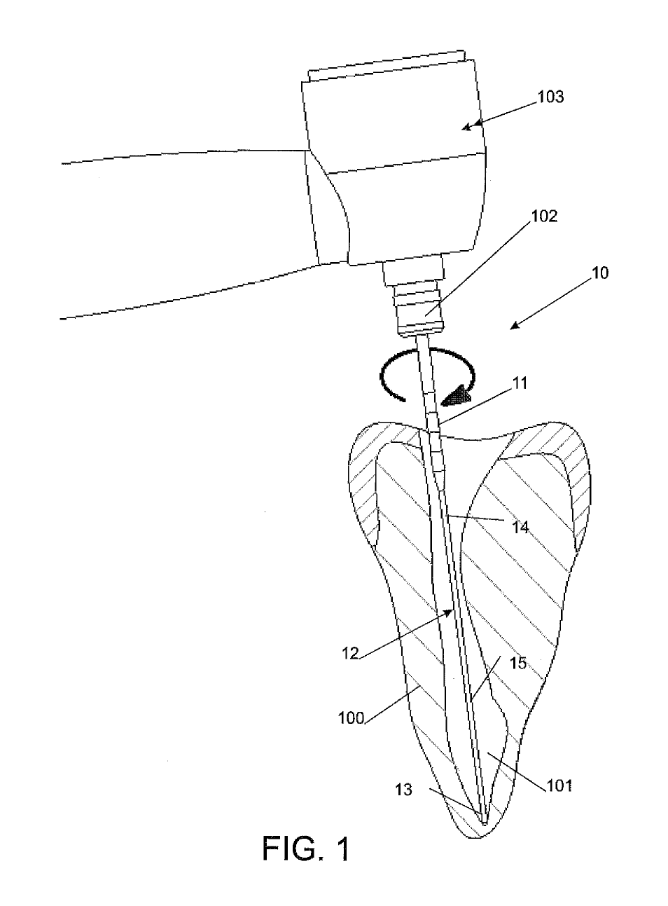

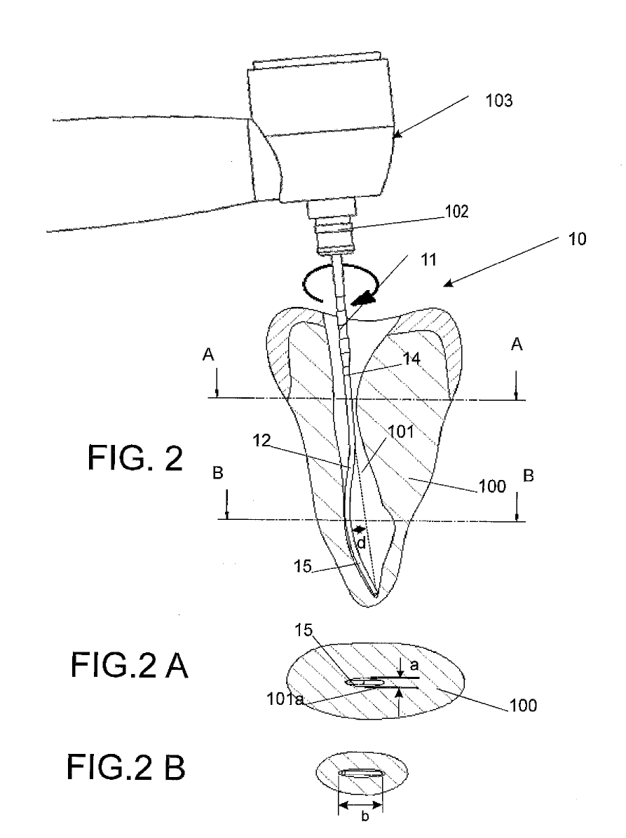

Referring to the figures, the endodontic instrument 10 that is designed for preparing a tooth 100 of a patient in the scope of a root treatment is an instrument for cleaning the (or a) root canal 101 of the tooth 100. Unlike prior art instruments for carrying out such a preparation, this instrument 10 is arranged for cleaning the inside walls of the cavity without “milling” or “drilling” the canal, but by following the natural path without cutting into the hard portion of the tooth. It is designed for having at least one static state, illustrated in particular by FIG. 1, and a dynamic state illustrated by FIG. 2. In its static state, it should be noted that the instrument has an essentially straight profile and that it, furthermore, has considerable suppleness or flexibility, which allows it to be easily introduced into the root canal 101 of the tooth 100. In its dynamic state, the instrument has a curved profile with at least one curvature, which enables it to fulfill its function of cleaning the walls of said root canal by brushing the inside surface of the walls of the root canal.

The endodontic instrument 10 comprises a rigid tip 11 arranged to be mounted on a rotating support 102 of an apparatus 103, known as a contra-angle, and a working sector 12. Said working sector comprises a free end section 13, and it is arranged for being engaged in said root canal 101. The working sector 12 is composed of a first essentially straight active segment 14 disposed in the extension of said rigid tip 11, and of a second active segment 15 comprising said free end section 13. In the static state (see FIG. 1), said second active segment 15 is essentially straight, and, in said dynamic state (see FIG. 2), said second active segment 15 has a curved shape between the point of connection to said first active segment and said free end 13. The curved shape of the active segment 15 can correspond to a circular arc or to any other profile approaching the shape of a circular arc (in particular see FIGS. 2 and 6), of which the sagitta d is the distance from the summit S of the arc to the line that connects its two ends M and N. In the context of this invention, the sagitta d of this arc has a length that is essentially between half of the smallest average cross section a of a root canal 101 and half of the largest cross section b of this root canal, when said instrument 10 is in its dynamic state.

FIG. 2 illustrates the instrument in its dynamic state in a first treatment phase when the end section 13 is inserted to the end of the root canal 101. When the instrument is rotated, its end section brushes the deepest zone of the canal and cleans the wails of this portion in order to remove the soft portions lining them, without cutting into the dentin. During the rotation, these portions are pushed to the top of the canal for removal it should be noted that, owing to the suppleness of the end section 13 and its curved shape that whisks the surface of the walls, this operation is performed regardless of the width of the canal, its geometry, its cross sectional dimensions, the presence, or not, of rough areas.

FIGS. 2A and 2B are sectional views along the planes A-A and B-B, respectively, of the tooth 100 showing oval sections 101a and 101b of a root canal 101 and sections of the active segment 15 of the working sector 12. The canal 101 could obviously have more complex shapes such as a C- or S-shaped cross section. Because of the flexibility of the working sector, all types of canals can be treated regardless of their geometry, hence it is possible to imagine a canal profile that can be considered as a standard having a more or less oval cross section, with a longitudinal dimension that is essentially 1 to 10 times larger than the corresponding cross section.

The instrument 10 is specifically designed for treating this type of root canals with non-circular cross sections on at least a portion of their path, or canals with complex profiles having at least one break or angular deviation along their lengths. Indeed, several difficulties are posed for these canals: the introduction of the instrument all the way into the canal (along its entire length) regardless of the geometric complexity of the canal, the active shaping of the working sector and the efficient cleaning of the walls due to the free, not slowed or braked rotation of the working sector. It has been shown that the shape described, with a single curved section disposed in the extension of a straight section, conferred a maximum of assets for accomplishing the task imposed.

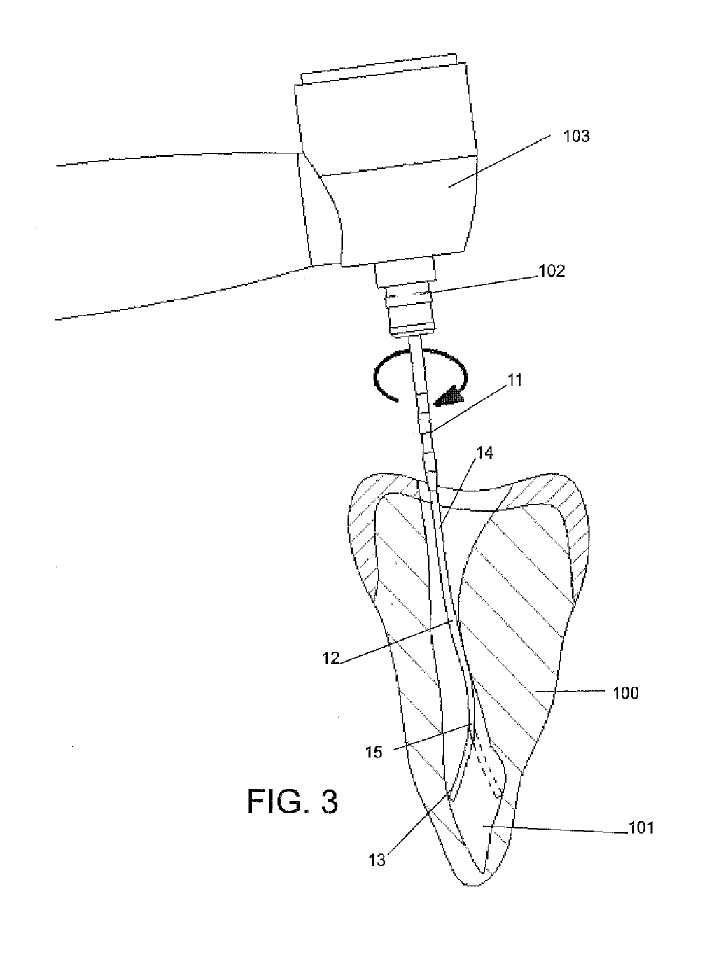

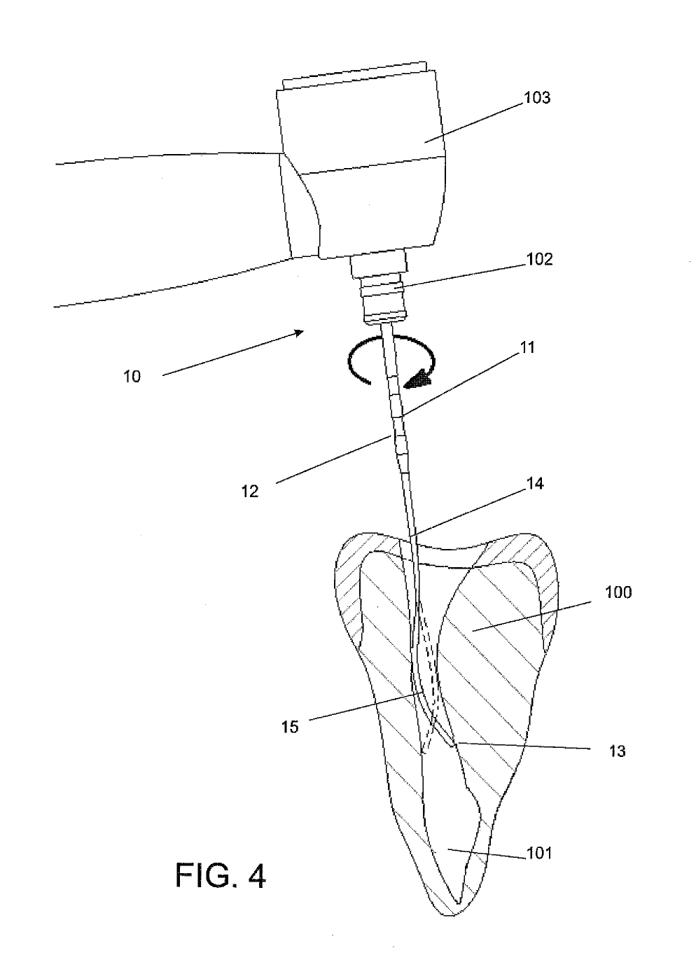

FIGS. 3 and 4 are two views of the representative instrument 10 in the course of different treatment phases, the instrument having been displaced along the canal between the two operations. By displacing the instrument in this fashion, the operator can brush the entire surface of the walls of the canal, along the entire length thereof.

The instrument 10 is advantageously made out of a shape memory metal alloy such that, under the influence of a temperature increase, it transitions from its static state, illustrated in FIG. 1, into its dynamic state, illustrated in FIG. 2. It can also have super elasticity properties, which are obtained by the choice of the alloy and by specific treatments, in particular heat treatments.

In a particularly advantageous manner, when the instrument is of the shape memory type, the static state is obtained at ambient temperature, in other words around 20° C., and the dynamic state is attained at body temperature, in other words around 32° C. to 37° C. This temperature increase can be achieved naturally, after introducing the working sector 12 into the root canal 101 or by supplying outside heat, for example by localized injection of a hot liquid, irradiation, or as a result of heating by the Joule effect.

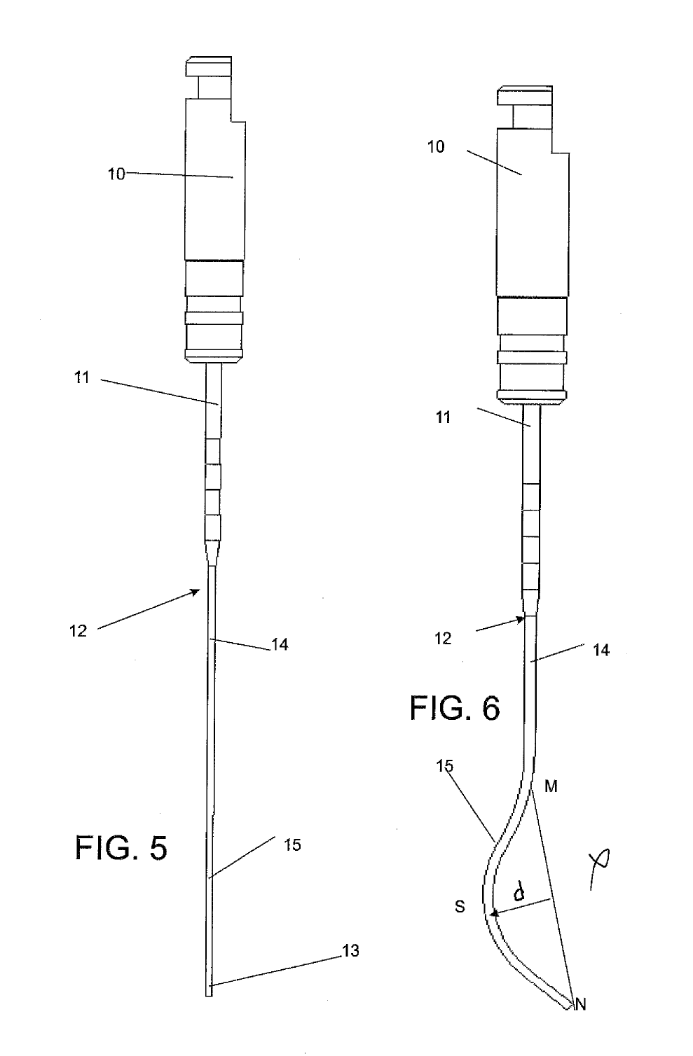

In its static state, the instrument 10 has, at rest as shown in FIG. 5 or at the start of the procedure as shown in FIG. 1, an essentially straight profile. As soon as it starts to rotate, as shown in FIG. 2 for example, in conjunction with irrigation with a liquid that assumes the body temperature, which has the effect of triggering the shape memory effect, the instrument regains its predefined shape illustrated in FIG. 6. In this state, the working sector 12 and more precisely the second active segment 15 of the instrument 10 contacts the canal walls. The second active segment 15 has a depth or sagitta d of the arc formed by said active segment 15. The sagitta d is the distance that separates the summit S of the arc from the segment MN that connects the two ends of the arc, corresponding to the curvature of the active segment 15. The length of this sagitta is between half of the smallest cross section a of the root canal 101 and half of the largest cross section b of this canal. In this manner and because of the rotation of the instrument, said active segment 15 acts as a whip that brushes against the walls of the canal and removes the soft portions that can line the surface thereof. Its function is that of cleaning the surface of the walls, regardless of the geometry thereof.

If it is of the shape memory type and when it is in its dynamic state, the instrument 10 is in the austenitic phase, in other words very supple and elastic, which enables it to scrape the surface of the walls of the root canal 101. The transition from one of the states to another can be linked to a change in temperature or to the application of vibrations that can be induced by ultrasound. It should be noted that the second active segment 15 of the instrument 10 touches the canal wall, regardless of the geometry of the canal. This feature is illustrated in particular by FIGS. 3 and 4, which illustrate the instrument 10 in relation to different levels of the canal. Regardless of the narrowness of the canal or the restriction of the passage or the cross section of the canal 101, the second active segment 15 is able to fulfill its function of cleaning the surface of the canal walls.

It should be noted that second active segment 15 of the instrument 10, which composes a portion of the working sector 12, advantageously comprises a single arc-shaped curved element only when the instrument is in its active state. In its passive state, the second active segment 15 is essentially straight.

During the use procedure, in other words while the active segment 15 is performing its function of cleaning the canal walls, it is possible to adjust, even reduce, the “scraping” force by injecting, with a syringe, an irrigant at ambient temperature. The cooling effect of this action transforms the NiTi from the austenitic phase to the martensitic phase, which will have the effect of reducing the “scraping” force on the canal walls.

After a certain use time, the super elastic effect will reestablish itself with the increase in the temperature of the irrigant, which is brought about by the temperature of the body or because of the heating due to the friction forces of the instrument.

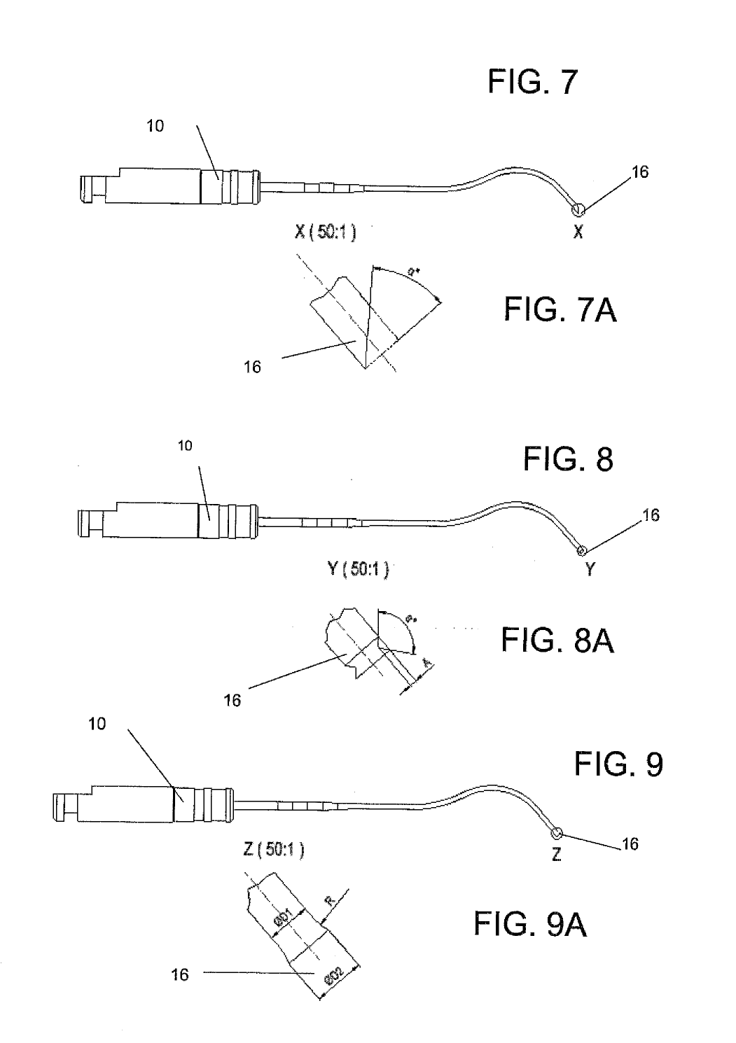

FIG. 7 and the detail FIG. 7A illustrate another embodiment of the instrument 10, in which the end section 13 comprises a tip 16 with a beveled profile, the angle of the bevel is between 60° and 30° and preferably around 45°. This angular section is advantageously sharp and makes it possible to cut, if necessary, the material in the end region of the root canal.

FIG. 8 and the detail FIG. 8A illustrate another embodiment of the instrument 10, in which the end section 13 comprises a tip 16 with a circular dovetail profile disposed transversely in relation to the axis of the tip 16. The dovetail profile has an opening angle of between 60° and 30° and preferably of around 45°. As in the preceding, the profile, which comprises two cutting edges, makes it possible to cut, if necessary, the material in the end region of the root canal.

FIG. 9 and the detail FIG. 9A illustrate another embodiment of the instrument 10, in which the end section 13 comprises a tip 16 with a flared profile. The end of the flared profile has a widening defined by a curvature radius R1; the opening angle of the flare is essentially between 120° and 150°. The edge of the flared profile is sharp in order to provide a cutting edge intended, if needed, for cutting the material along the walls of the root canal.

The purpose of the different forms described above is that of improving the action of the instrument, namely, the cleaning of the walls. In certain cases, the end profiles can be adapted to specific milling operations for removing material along the walls of the root canal or for removing filling material used during a prior procedure.

This invention is not limited to the embodiments described here. Various modifications or variants obvious to persons skilled in the art are possible. In particular, use could be made of other materials such as certain plastics, or composites of synthetic materials and/or of fibers, in particular carbon fibers.

1-12. (canceled)

13. An endodontic instrument for preparing a tooth of a patient, in particular an instrument for cleaning the root canal that follows a natural geometry of the canal,
the instrument being made of a shape memory material and having a first static state and a second dynamic state,
the first static state corresponding to a substantially straight geometry for facilitating partial introduction of the instrument into the root, and the second dynamic state corresponding to a structured geometry and a supple and flexible hold,
the endodontic instrument being rotationally driven in order to clean an inner wall of the root canal by following its natural geometry, and having a rigid tip arranged for being mounted on a rotating support, and
a working section arranged for being engaged in the root canal,
wherein, in the dynamic state of the instrument, the working sector is composed of a first, substantially straight active segment and at least a second active segment disposed in an extension of the first active sector, the at least one second active segment having a free end tip with a curved shape between the point of connection to the first active segment and the free end tip, the curved second active segment having a sagitta (d), a length of which is between a largest half cross section (a) of the root canal and a smallest cross section (b) of the root canal.

14. The endodontic instrument according to claim 13, wherein the free end tip has a structured geometric shape.

15. The endodontic instrument according to claim 14, wherein the end tip has a beveled shape.

16. The endodontic instrument according to claim 15, wherein the bevel has an angle of between 30° and 60°.

17. The endodontic instrument according to claim 13, wherein the free end tip comprises a dovetailed tip.

18. The endodontic instrument according to claim 17, wherein the dovetail has an opening angle in the range of between 60° and 30°.

19. The endodontic instrument according to claim 13, wherein the free end tip comprises a flared tip.

20. The endodontic instrument according to claim 19, wherein the free end tip has a flare defined by a curvature radius (R1).

21. The endodontic instrument according to claim 18, wherein the free end tip has a widening defined by an angle that is between 120° and 150°.

22. The endodontic instrument according to claim 13, wherein the endodontic instrument is made of a shape memory metal alloy in which a transition, from a martensitic phase to an austenitic phase, occurs naturally at the body temperature between 32° C. and 37° C.

23. The endodontic instrument according to claim 13, wherein the endodontic instrument is made of a shape memory metal alloy in which a transition from a martensitic phase to an austenitic phase is brought about by a temperature increase induced by injecting a hot liquid into the root canal,

24. The endodontic instrument according to claim 13, wherein the endodontic instrument is made of a metal alloy having super elasticity properties which are acquired as a result of a heat treatment.

25. The endodontic instrument according to claim 13, wherein the endodontic instrument is made of a shape memory metal alloy in which a transition from a martensitic phase to an austenitic phase is brought about by application of vibrations induced by ultrasound.

26. The endodontic instrument according to claim 15, wherein the bevel has an angle of at least approximately equal to 45°.

27. The endodontic instrument according to claim 17, wherein the dovetail has an opening angle about 45°.
